(19) United States
(12) Patent Application Publication
(10) Pub. No.: US 2016/0053798 A1
(43) Pub. Date: Feb. 25, 2016

(54) A SECURING DEVICE

(71) Applicant: INTELLIGENT ENERGY LIMITED, Loughborough (GB)

(72) Inventor: Stuart SMITHERS, Loughborough (GB)

(73) Assignee: INTELLIGENT ENERGY LIMITED, Loughborough (GB)

(21) Appl. No.: 14/779,154

(22) PCT Filed: Mar. 20, 2014
(86) PCT No.: PCT/GB2014/050875

§ 371 Date: Sep. 22, 2015

(30) Foreign Application Priority Data
Mar. 26, 2013 (GB) 1305462.2

(51) Int. Cl. F16B 21/07; F16B 37/08

(52) U.S. Cl. CPC F16B 21/073; F16B 37/0857

(57) ABSTRACT

The disclosure relates to a securing device (100) for an elongate member, the securing device (100) comprising a plurality of teeth (108) that are configured to engage an outer surface of the elongate member such that the teeth (108) provide less of a barrier to movement of the securing device (100) relative to the elongate member in a first axial direction (104) than in an opposite, second axial direction (106), wherein the teeth (108) are spaced apart from each other both in an axial direction (104, 106) and a circumferential direction (114).

The present disclosure relates to securing devices and, in particular, to a securing device for an elongate member.

Mechanisms for securing poles and rods in position are required in a number of fields. In some applications it may be necessary to secure a load on a rod under tension. In fuel cell applications, tie rods can be used to secure fuel cells in position and under compression in a fuel cell stack assembly. Other applications that require a load to be held under tension include electrical or air handling systems that hang from cables on building frameworks, for example. The securing of such loads may be achieved by the use of nuts and bolts.

According to a first aspect of the invention there is provided a securing device for an elongate member, the securing device comprising a plurality of teeth that are configured to engage an outer surface of the elongate member such that the teeth provide less of a barrier to movement of the securing device relative to the elongate member in a first axial direction than in an opposite, second axial direction, wherein the teeth are spaced apart from each other both in an axial direction and a circumferential direction.

The securing device may allow “one-way” or “non-return” insertion of the securing device onto the elongate member. Such a device may hold an elongate member that has a tensile load applied to it in an axial direction more securely. The securing device enables the length of the elongate member to be less critical than may be the case with elongate members that have integral securing functionality, such as a screw-thread. That is, any tolerances in the manufacture of the length of the elongate member may not affect the ability of the securing device to properly engage with the elongate member.

The securing device may further comprise a cavity through the thickness of the securing device thereby defining an aperture in opposing external surfaces of the securing device.

The plurality of teeth may be provided on an inwardly facing surface of the securing device that defines the cavity.

The plurality of teeth may be resiliently biased. The point of each of the plurality of teeth may extend to a position that is inside the aperture at each end of the cavity. Providing the teeth in this way enables them to engage an outer surface of the elongate member when the securing device is fitted on to an elongate member.

The bias force may have a component in the first axial direction. At least a portion of the plurality of teeth may be configured to be displaced in the second axial direction by insertion of the elongate member. Such an arrangement of teeth can allow for an increase in the tensile strength that can be loaded on to the securing device by the elongate member when compared with teeth that are only spaced apart circumferentially.

Each of the plurality of teeth may comprise a first contact surface. The first contact surface may be oblique to the second axial direction. The first contact surface may extend in the second axial direction as the first contact surface extends towards the point of the tooth. Each of the plurality of teeth may comprise a second contact surface that is on the opposite side of each tooth to the first contact surface. The second contact surface may be oblique to the second axial direction. The second contact surface may extend in the second axial direction as the second contact surface extends towards the point of the tooth.

The plurality of teeth may comprise a plurality of rings of teeth. The plurality of rings of teeth may be separated from one another in the axial direction by one or more spacing elements. The plurality of teeth may be arranged in modules that are separable from the securing device. The modules may comprise a sub-section of a ring of teeth that are aligned in a radial plane that is normal to the axial direction. The plurality of teeth may be arranged in a helical pattern. The plurality of teeth may be arranged on an inner surface of the securing device. The plurality of teeth may be configured to provide shark tooth functionality.

There may be provided an apparatus comprising any securing device disclosed herein and an elongate member. The apparatus may be a fuel cell stack assembly.

The securing device may deliver a required load profile to the fuel cell stack for a range of geometric values, including any variance in dimensions of the fuel cell stack that may exist due to tolerances in stack manufacture. In this way, good tolerance compliance can be provided. This can improve performance of the fuel cell stack and/or reduce the physical volume occupied by a fuel cell stack assembly comprising the securing device and the fuel cell stack.

The elongate member may comprise a tie rod of the fuel cell stack assembly. The securing device may be comprised by an end plate of the fuel cell stack assembly.

A description is now given, by way of example only, with reference to the accompanying drawings, in which:

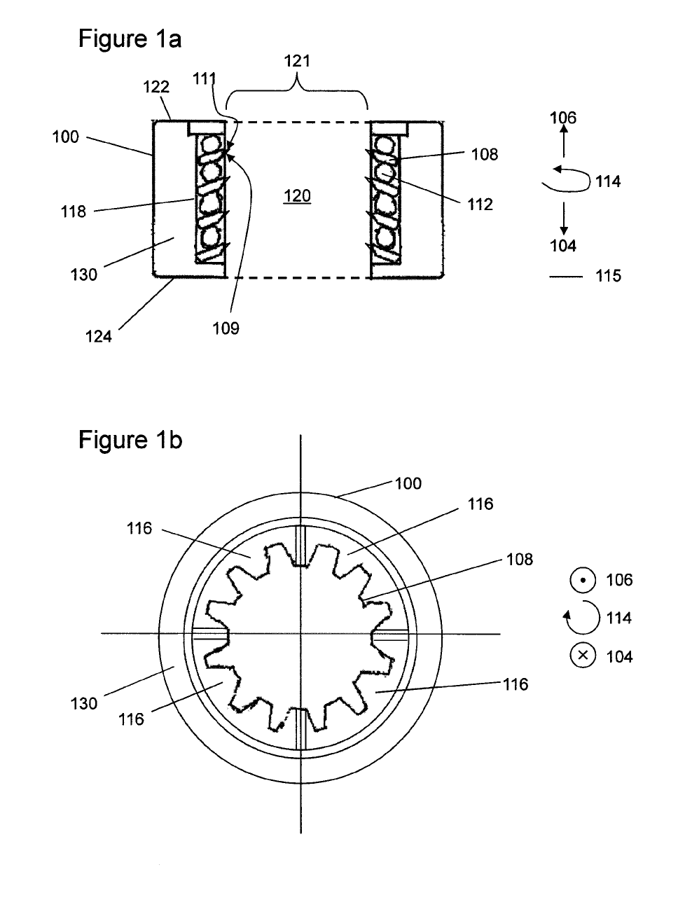

FIG. 1a shows a vertical cross sectional view of a securing device;

FIG. 1b shows a horizontal cross sectional view of the securing device of FIG. 1a;

FIG. 1c shows a vertical cross sectional view of a tooth of the securing device of FIG. 1a;

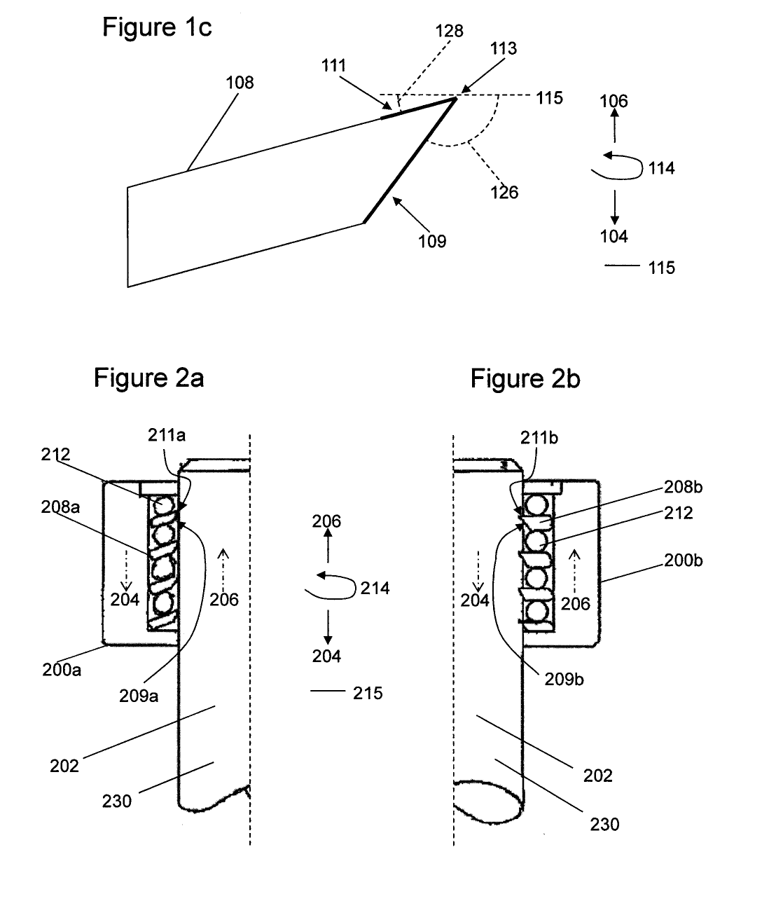

FIG. 2a shows a vertical cross sectional view of a securing device engaged with an elongate member where a force is applied in a direction such that the securing device is moved relative to the elongate member; and

FIG. 2b shows a vertical cross sectional view of a securing device engaged with an elongate member where a force is applied in a direction such that the securing device is held in position relative to the elongate member.

One or more embodiments disclosed herein provide a securing device that offers more secure holding of an elongate member that has a tensile load applied to it in an axial direction. The securing device has a plurality of teeth spaced apart in both the axial and a circumferential direction so as to provide an improved engagement with the elongated member.

FIGS. 1a and 1b illustrate features of a securing device 100 for an elongate member. FIG. 1a shows a vertical cross sectional view of the securing device 100. FIG. 1b shows a horizontal cross sectional view of the securing device 100. A first axial direction 104, second axial direction 106 and circumferential direction 114 are shown in FIGS. 1a and 1b. The second axial direction 106 is opposite to the first axial direction 104. In general, reference to “an axial direction” may refer to either the first or second axial direction. The circumferential direction 114 is both normal to an axial direction and co-linear with the perimeter of the elongate member. The securing device has a radial plane 115 that is normal to the axial directions 104, 106.

The securing device 100 has a housing 130, which has a cavity 120 through its thickness extending between an aperture 121 in the top surface 122 and an aperture in the bottom surface 124 of the housing 130. The top and bottom surfaces 122, 124 are opposing external surfaces of the securing device 100. The apertures 121 are shaped to correspond with the perimeter (the cross-sectional shape) of the elongate member, which in this example is circular. The diameter of the apertures 121 is the same as, or slightly greater than, the diameter of the elongate member.

A plurality of teeth 108 are provided on an inwardly facing surface of the securing device 100 that defines the cavity 120, thereby facing a perimeter of the outer surface of the elongate member, when in use. As shown in FIG. 1a, a plurality of teeth 108 are spaced apart in the axial direction of the securing device 100. As shown in FIG. 1b, a plurality of teeth 108 are spaced apart in the circumferential direction 114 of the securing device 100. Such an arrangement of teeth can allow for an increase in the tensile strength that can be loaded on to the securing device 100 by the elongate member when compared with teeth that are only spaced apart circumferentially.

The teeth 108 in FIGS. 1a and 1b are shown at rest, at which time the diameter of a circle defined by the point of each tooth 108 is less than the diameter of the elongate member with which the securing device 100 is to be engaged. In this example, the point of each tooth 108 extends to a position that is inside the aperture 121 at each end of the cavity 120. Providing the teeth 108 in this way enables them to engage an outer surface of the elongate member when the securing device 100 is fitted on to an elongate member.

The teeth 108 are resiliently biased to their at-rest position, either by properties of the material from which they are formed or by an external component. Such biasing force has a component in the first axial direction 104 as described in more detail below.

FIG. 1c illustrates a single tooth 108 in greater detail. Each tooth 108 includes a first contact surface 109 which is oblique to the axial directions 104, 106. The first contact surface 109 extends in the second axial direction 106 as the surface extends towards the point 113 of the tooth 108. The first contact surface 109 is an example of an oblique surface of a tooth 108. That is, an obtuse angle 126 is defined between the radial plane 115 of the securing device 100 and an exterior of the first contact surface 109.

Each tooth 108 also includes a second contact surface 111 that is on the opposite side of the tooth 108 to the first contact surface 109. The second contact surface 111 in this example is also an oblique contact surface as it also extends in the second axial direction 106 as the second contact surface 111 extends towards the point 113 of the tooth 108. That is, an acute angle 128 is defined between the radial plane 115 of the securing device 100 and an exterior of the second contact surface 111. In other embodiments, the second contact surface 111 may be generally parallel with the radial plane 115 of the securing device 100.

The orientation of the first contact surface 109 and second contact surface 111 can enable the teeth 108 to provide less of a barrier to movement of the securing device 100 relative to the elongate member in the first axial direction 104 than in the second opposite axial direction 106. This enables the securing device 100 to be conveniently fitted onto the elongate member by moving it in a first axial direction 104, whilst also being able to support a tensile load that pushes on the securing device 100 in the second axial direction 106. In this way, the securing device 100 can be considered as self-locking. Further details are provided below with reference to FIGS. 2a and 2b.

In this example, multiple rows of teeth 108 are spaced apart in the axial direction. A row of teeth 108 can be considered as a plurality of teeth 108 in the same radial plane of the securing device 100. The multiple rows of teeth 108 can be provided in the form of a ring of teeth 108 made from hardened spring steel, for example. Each ring of teeth 108 may be separated from adjacent rings by a spacing member 112, as shown in FIG. 1a. The spacing members 112 may be resiliently deformable in order to allow the teeth to be displaced. Alternatively, the teeth can resiliently deform and the spacing members 112 may simply space the teeth 108 apart.

The spacing member 112 may be a spring, an “0” ring or a nylon spacer, as non-limiting examples. A ‘ring’ may take any continuous three dimensional shape and is not limited to toroids. The provision of spacing members 112 can allow the teeth 108 to be displaced in the second axial direction 106 when the securing device 100 is moved in the first axial direction 104 over the elongate member and resiliently bias the teeth 108 back to their at-rest position. Further details are provided below with reference to FIGS. 2a and 2b.

The rings of teeth 108 and spacing members 112 are alternately arranged in an axial direction 104, 106 within the housing 130. The rings of teeth 108 and spacing members 112 are housed in a recess 118 within the cavity 120 in order to retain the teeth 108 and spacing members 112 in an axial direction 104, 106. The rings of teeth 108 may not be fixed to the housing 130 such that they can rotate in the radial plane 115 within the recess 118 of the securing device 100. That is, the rings of teeth 108 may be rotatably mounted in the securing device 100. A groove may be provided in the inner surface of the recess 118 in order to assist such rotational functionality. An advantage of providing a securing device 100 with rotatable teeth is that the elongate member may then rotate with respect to the securing device 100 whilst restricting relative axial movement between the securing device 100 and the elongate member.

The plurality of teeth 108 are arranged in modules 116 in FIGS. 1a and 1b. These modules 116 can be provided as separable units that can be added to or removed from the securing device 100 depending on the amount of load bearing required. The provision of a modular tooth 108 system may also provide a more flexible and cheaper method of manufacturing the securing device 100. The teeth 108 or modules 116 may be provided in a range of standard sizes.

As shown in FIG. 1b, a module 116 can comprise one or more sub-sections of a ring of teeth 108. In FIG. 1b, each module 116 represents one or a plurality of quadrants of rings of teeth 108 that are spaced apart in an axial direction 104, 106 (only one quadrant per module 116 is visible in FIG. 1b). The four modules 116 combine to provide complete rings of teeth 108.

In other examples, the plurality of teeth 108 can be arranged in a helical pattern in order to be spaced apart in both an axial direction 104, 106 and circumferential direction 115.

FIGS. 2 and 2b illustrate a vertical cross-section through a securing device 200 engaged with an elongate member 202. Teeth 208a of the securing device 200a of FIG. 2a are shown in an orientation that corresponds to the securing device 200a being moved in the first axial direction 204. Teeth 208b of the securing device 200b of FIG. 2b are shown in an orientation that corresponds to a force being applied to the securing device 200b in the second axial direction 206. Features of FIGS. 2a and 2b that have already been described in relation to FIG. 1 will not necessarily be described again with reference to FIGS. 2a and 2b.

FIG. 2a corresponds to the action of the securing device 200 being fitted onto the elongate member 202. As the securing device 200a moves in the first axial direction 204, the outer surface of the elongate member 202 applies a force to a first contact surface 209a of the respective teeth 208a in the second axial direction 206. When such a force is applied to the first contact surfaces 209a, the teeth 208a either deform or are displaced such that the elongate member 202 can move past the teeth 208a. That is, the points of the teeth 208a may be relocated to positions such that the diameter of a circle with a circumference defined by the points of the teeth 208a corresponds to, or is greater than, the diameter of the elongate member 202. Optionally, the spacing member 212 next to each ring of teeth 208a may be compressed or otherwise deformed to accommodate the movement or deformation of the teeth 208a. As such, there is a reduced contact force between the teeth 208a and the elongate member 202 when the securing device 200a is moved in the first axial direction 204 relative to the elongate member 202.

FIG. 2b corresponds to the action of a tensile load force being applied to the securing device 200b relative to the elongate member 202 in the second axial direction 206. Such a tensile load force may be generated when the securing device 200b and elongate member 202 are used to secure components such as a fuel cell stack in compression. The teeth 208b engage with the outer surface of the elongate member 202 and resist the movement of the securing device 200b relative to the elongate member 202 in the second axial direction 206. The outer surface of the elongate member 202 applies a force to the second contact surface 211b of the teeth 208b in the first axial direction 204.

In this example, this force brings the second contact surface 211b closer to a position that is generally parallel to a radial plane 215 of the elongate member 200. The teeth 208b then bite into the elongate member 202 to resist further movement of the securing device 200 relative to the elongate member 202 in the second axial direction 206. The biting action can be considered to form a “head” to the elongate member 202. This “biting into” the elongate member is shown on the right-hand side of FIG. 2 as the points of the teeth 208b are within or pressed against the original confines of the elongate member 202.

In some examples, the teeth may be shaped as sharks' teeth. Such teeth have an oblique first contact surface and an oblique second contact surface. The first and second contact surfaces may be similar to those discussed above with respect to FIG. 1.

Any securing device described herein may be considered to provide a non-release solution for holding the elongate member in tension. That is, the securing device can allow “one-way” or “non-return” insertion of the securing device onto the elongate member.

The securing device enables the length of the elongate member to be less critical than may be the case with elongate members that have integral securing functionality, such as a screw-thread. That is, any tolerances in the manufacture of the length of the elongate member may not affect the ability of the securing device to properly engage with the elongate member; it can be attached at any location on the elongate member.

The elongate member may be a pole, rod, or shaft, and may or may not have a circular cross-section. For example, the cross section of the elongate member may be square or hexagonal.

It will be appreciated that two securing devices could be used; one at each end of the same elongate member.

In order for the teeth to bite into the elongate member it may be necessary for the teeth to be harder than the outer surface of the elongate member. Specifically, the points of the teeth, with which the elongate member engages, may need to be harder than the elongate member.

The securing device may be employed in fuel cell applications. For example, a mechanism can be required to secure tie rods in place to hold fuel cell stack assemblies together under compression. It can be beneficial for there to be flexibility allowed in the final length of the fuel cell stack (and therefore also the tie rod length required) due to variance in the sum of tolerances of the components in different instances of the fuel cell stack. The ability to easily vary the distance between securing devices along a tie rod is advantageous to enable the assembled stack to be reliably “built to load”, as opposed to “built to dimension”. For example, components within the stack may need to be held under compression to ensure that seals and gaskets within the stack function correctly. One or more of the securing devices disclosed herein can enable sufficient compressive load to be applied to the fuel cell stack.

Furthermore, the securing device can deliver a required load profile to the fuel cell stack for a range of geometric values, including any variance in dimensions of the fuel cell stack that may exist due to tolerances in stack manufacture. In this way, good tolerance compliance can be provided. This can improve performance of the fuel cell stack and/or reduce the physical volume occupied by a fuel cell stack assembly comprising the securing device and the fuel cell stack.

The securing device could, for example, be placed in or on an end plate of a fuel cell stack assembly and engage with a tie rod that is passed through or alongside the fuel cells. Providing a securing device integrated into the end plate can reduce the complexity of production of the fuel cell stack and so improve the uniformity of pressure applied to various instances of the fuel cell stack assemblies.

It will be appreciated that the term circumferential direction may apply to prismatic elongate members as well as cylindrical elongate members. The teeth may be arranged on an inner surface of a cylindrical or prismatic portion of the securing device. The circumferential direction may also be referred to as an orthogonal direction.

1. A securing device for an elongate member, the securing device comprising a plurality of teeth that are configured to engage an outer surface of the elongate member such that the teeth provide less of a barrier to movement of the securing device relative to the elongate member in a first axial direction than in an opposite, second axial direction, wherein the teeth are spaced apart from each other both in an axial direction and a circumferential direction.

2. The securing device of claim 1, further comprising a cavity through the thickness of the securing device thereby defining an aperture in opposing external surfaces of the securing device, wherein the plurality of teeth are provided on an inwardly facing surface of the securing device that defines the cavity.

3. The securing device of claim 2, wherein the plurality of teeth are resiliently biased such that the point of each of the plurality of teeth extends to a position that is inside the aperture at each end of the cavity.

4. The securing device of claim 3, wherein the bias force has a component in the first axial direction.

5. The securing device of claim 3, wherein at least a portion of the plurality of teeth is configured to be displaced in the second axial direction by insertion of the elongate member.

6. The securing device of claim 1, wherein each of the plurality of teeth comprises a first contact surface which is oblique to the second axial direction and extends in the second axial direction as the first contact surface extends towards the point of the tooth.

7. The securing device of claim 6, wherein each of the plurality of teeth comprises a second contact surface that is on the opposite side of each tooth to the first contact surface, and wherein the second contact surface is oblique to the second axial direction and extends in the second axial direction as the second contact surface extends towards the point of the tooth.

8. The securing device of claim 1, wherein the plurality of teeth comprise a plurality of rings of teeth that are separated from one another in the axial direction by one or more spacing elements.

9. The securing device of claim 1, wherein the plurality of teeth are arranged in modules that are separable from the securing device.

10. The securing device of claim 9, wherein the modules comprise a sub-section of a ring of teeth that are aligned in a radial plane that is normal to the axial direction.

11. The securing device of claim 1, wherein the plurality of teeth are arranged in a helical pattern on an inner surface of the securing device.

12. The securing device of claim 1, wherein the plurality of teeth are configured to provide shark tooth functionality.

13. An apparatus comprising the securing device of claim 1, and further comprising an elongate member.

14. The apparatus of claim 13, wherein the apparatus is a fuel cell stack assembly and the elongate member comprises a tie rod of the fuel cell stack assembly.

15. The apparatus of claim 14, wherein the securing device is comprised by an end plate of the fuel cell stack assembly.

16-17. (canceled)
